(19) United States
(12) Patent Application Publication
(10) Pub. No.: US 2014/0335295 A1
(43) Pub. Date: Nov. 13, 2014

(54) FOAM MOLDED PRODUCT AND METHOD FOR PRODUCING SAME

(71) Applicant: KYORAKU Co., Ltd., Kyoto (JP)

(72) Inventor: Masaaki Onodera, Yamato-shi (JP)

(73) Assignee: KYORAKU CO., LTD., Kyoto (JP)

(21) Appl. No.: 14/358,804

(22) PCT Filed: Nov. 9, 2012
(86) PCT No.: PCT/JP2012/079095

§ 371 Date: May 16, 2014

(30) Foreign Application Priority Data
Nov. 18, 2011 (JP) 2011-253000

(51) Int. Cl. B60H 1/00; C08L 23/12; B29C 44/02

(52) U.S. Cl. CPC B60H 1/00564; B29C 44/02; B60H 1/00028; C08L 23/12; B60H 2001/00235; C08L 2203/14; C08L 2205/03
USPC 428/36.5; 264/50; 296/210; 521/139

(57) ABSTRACT

A foam molded product includes a mixture resin including, as base resins, a polypropylene-based resin with a long-chain branching structure and a weight mixing ratio of 60 to 80%, a styrene-ethylene/butylene-styrene block copolymer with a styrene content of 15 to 40% and a weight mixing ratio of 15 to 35%, and a polyethylene-based resin with a long-chain branching structure, which has a density of not more than 0.930 g/cm³ and a weight mixing ratio of 5 to 25%.

### TECHNICAL FIELD

The present invention relates to a foam molded product used for an air-conditioning duct for vehicles, and a method for producing the same.

### BACKGROUND ART

Generally, an air-conditioning duct for vehicles for supplying air-conditioning air from an on-board air conditioner unit to a desired location is known.

Such an air-conditioning duct for vehicles is required to be lightweight and have thermal insulation property. Thus, a molded product of foamed resin is generally used for the air-conditioning duct for vehicles.

Regarding such a foam molded product, the present applicant has attempted to form a foam molded product that is lightweight and has excellent shock resistance by a technology using a mixture resin containing a foaming polypropylene-based resin and a hydrogenated styrene-based thermoplastic elastomer with a styrene content of 15 to 25 wt % (see, for example, Patent Literature 1).

An attempt has also been made to form a foam molded product which is lightweight and has excellent shock resistance with an inexpensive material, using a base resin mixing a propylene homopolymer with a long-chain branch, a propylene-ethylene block copolymer, and a low density polyethylene (see, for example, Patent Literature 2).

### CITATION LIST

### Patent Literature

Patent Literature 1: JP-A-2011-51180
Patent Literature 2: JP-A-2011-116804

### SUMMARY OF INVENTION

### Problems to be Solved by the Invention

However, in the air-conditioning duct for vehicles described above, for example, higher levels of lightweight property and thermal insulation property than those according to Patent Literatures 1 and 2 are required to increase fuel economy and reduce materials.

Further, in the case of an air-conditioning duct at the roof side of a vehicle, a curtain air-bag for protecting the passenger from a side collision is disposed in close proximity. Thus, the air-conditioning duct needs to not become broken or shatter even when the curtain air-bag is deployed by the force of pressurized gas. Thus, it is necessary to ensure sufficient shock resistance strength even when the expansion ratio is increased so as to increase lightweight property and thermal insulation property.

When the shock resistance of the air-conditioning duct is lacking, an anti-shattering and breakage measure needs to be implemented by affixing a shatterproof tape on the air-bag, resulting in an increase in cost.

The present invention was made in view of such a circumstance, and an object of the present invention is to provide a foam molded product such that the expansion ratio can be increased and higher levels of lightweight property and thermal insulation property can be realized, while sufficient shock resistance is provided, and to provide a method for producing the same.

### Solutions to the Problems

In order to achieve the objective, a foam molded product according to the present invention is a foam molded product obtained by molding a mixture resin including, as base resins, a polypropylene-based resin, a styrene-ethylene/butylene-styrene block copolymer, and a polyethylene-based resin, wherein the polypropylene-based resin has a long-chain branching structure and a mixing ratio of 60 to 80% by weight of the base resin; the styrene-ethylene/butylene-styrene block copolymer has a styrene content of 15 to 40% and a mixing ratio of 15 to 35% by weight of the base resin; and the polyethylene-based resin has a long-chain branching structure, a density of not more than 0.930 g/cm³, and a mixing ratio of 5 to 25% by weight of the base resin.

A method for producing a foam molded product according to the present invention is a method for producing a foam molded product, the method including adding a foaming agent to a base resin in which a polypropylene-based resin, a styrene-ethylene/butylene-styrene block copolymer, and a polyethylene-based resin are mixed, and foam-molding the base resin, wherein the polypropylene-based resin has a long-chain branching structure, and a mixing ratio of 60 to 80% by weight of the base resin; the styrene-ethylene/butylene-styrene block copolymer has a styrene content of 15 to 40%, and a mixing ratio of 15 to 35% by weight of the base resin; and the polyethylene-based resin has a long-chain branching structure, a density of not more than 0.930 g/cm³, and a mixing ratio of 5 to 25% by weight of the base resin.

### Effects of the Invention

Thus, according to the present invention, the expansion ratio can be increased while sufficient shock resistance is provided, whereby high levels of lightweight property and thermal insulation property can be realized.

### BRIEF DESCRIPTION OF THE DRAWINGS

FIG. 1(a) is a perspective view of a lightweight air-conditioning duct for vehicles (foam molded product) according to the present embodiment as used as a roof side duct, and FIG. 1(b) is a sagittal cross sectional view taken along line X-X′ of (a).

FIG. 2 is a cross sectional view of the roof side duct illustrated in FIG. 1 as attached to a vehicle.

FIG. 3 is a cross sectional view illustrating blow molding of the roof side duct illustrated in FIG. 1.

FIG. 4 is a perspective view of the lightweight air-conditioning duct for vehicles according to the present embodiment as used as an air conditioning floor duct.

### DESCRIPTION OF EMBODIMENTS

An embodiment in which the foam molded product and the method for producing the same according to the present invention are applied to a vehicle air-conditioning duct will be described in detail with reference to the drawings.

It is noted that the present invention is not limited to vehicle air-conditioning ducts and may be applied in other foam molded products, such as automobile interior components including door panels, instrument panels, and vehicle deck boards; housing interior wall materials; electronic device housings; and gas or liquid supplying ducts for purposes other than vehicles.

In the following description, the same elements are designated with the same signs in the drawings, and redundant descriptions are omitted. The positional relationships, such as top and bottom and left and right, are based on the position relationships illustrated in the drawings unless otherwise noted. Further, the dimensional ratios of the drawings are not limited to the ratios illustrated in the drawings.

### First Embodiment

A first embodiment of the present invention will be described. In the first embodiment, a case in which a vehicle air-conditioning duct as an embodiment of the present invention is a roof side duct will be described.

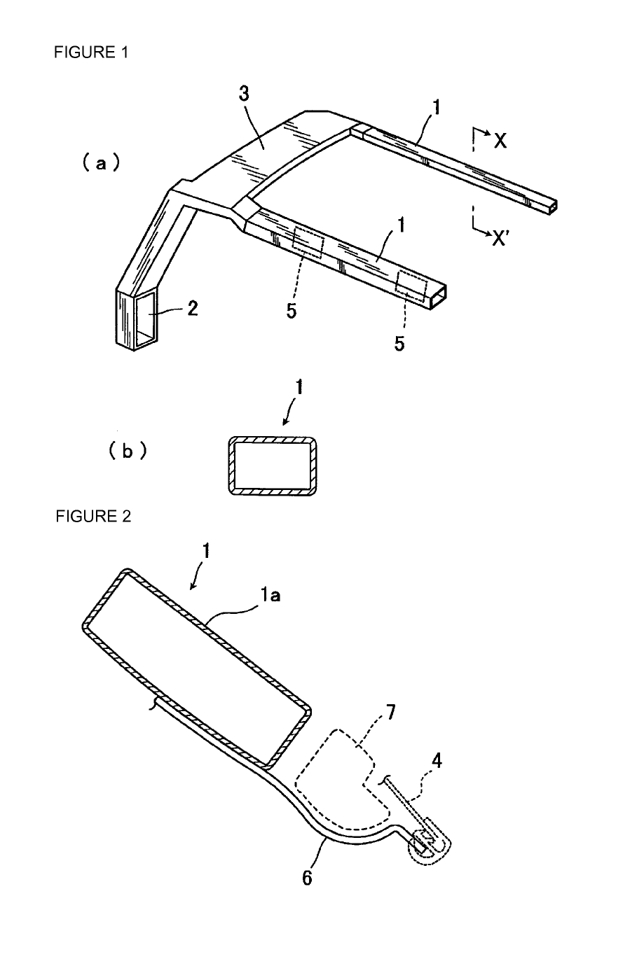

FIG. 1(a) is a perspective view of the roof side duct according to the present embodiment. FIG. 1(b) is a sagittal cross sectional view taken along line X-X′ in (a).

As illustrated in FIGS. 1(a) and (b), a roof side duct 1 according to the present embodiment is for sending air-conditioning air supplied from an air conditioner unit to a desired location.

The roof side duct 1 has a hollow polygonal column shape, and is integrally formed by blow molding. Blow molding will be described below.

The roof side duct 1 is supported on a transverse duct 3 on a flat board. The transverse duct 3 includes an air supply opening 2 on one end for supplying air-conditioning air. The air-conditioning air supplied from the air supply opening is circulated through the inside of the transverse duct, which is not illustrated, and then flows into a hollow portion of the roof side duct 1.

The air-conditioning air is then discharged via an air discharge opening 5 provided in the roof side duct 1.

The roof side duct 1 includes a wall portion 1a with an average thickness of not more than 3.5 mm. By thus decreasing the thickness of the wall portion 1a of the roof side duct 1, the flow passageway for the air-conditioning air circulated within the roof side duct 1 can be widely set.

Preferably, foamed cells have an average cell diameter of less than 300 μm in a thickness direction of the wall portion 1a. In this case, an advantage that mechanical strength is increased can be obtained. Further preferably, the average cell diameter is less than 100 μm.

The roof side duct 1 includes an independent air bubble structure with an expansion ratio of 3.0 times or more. The expansion ratio is a value obtained by dividing the density of the thermoplastic resin used for foam blow molding by the apparent density of the wall portion 1a of the foam blow molded product. The independent air bubble structure refers to a structure with a plurality of foamed cells, with the independent cell content of at least 70% or greater.

When the expansion ratio is 3.0 times or more, compared with a case in which the expansion ratio is less than 3.0 times, the weight can be further decreased, and thermal insulation property can be further increased. Thus, even when cooling air is circulated in the duct, the likelihood of dew condensation can be almost eliminated.

As illustrated in FIG. 2, the roof side duct 1 is disposed between an interior roof material 6 of the vehicle and a vehicle body panel 4, alongside a curtain air-bag 7.

Thus, when the curtain air-bag 7 is deployed by pressurized gas, the deployment shock of the curtain air-bag 7 is transmitted to the roof side duct 1 disposed behind the curtain air-bag 7.

Accordingly, the roof side duct 1 is required to have shock resistance such that shattering or breakage is not caused by the deployment shock when the curtain air-bag 7 is deployed by pressurized gas. If there is the possibility of shattering or breakage due to the shock of deployment of the curtain air-bag 7, a need for affixing shatterproof tape onto the curtain air-bag 7 will arise, causing cost increases.

Thus, the roof side duct 1 preferably has a tensile fracture elongation of not less than 40% at −10° C. and more preferably not less than 100%. The tensile fracture elongation refers to a value measured according to JIS K-7113.

If the tensile fracture elongation at −10° C. is less than 40%, compared with when the tensile fracture elongation is not less than 40%, the likelihood of shattering or breakage by the shock of deployment of the curtain air-bag 7 by pressurized gas is increased.

The roof side duct 1 according to the present embodiment may be obtained by foam blow molding a base resin in which a foaming polypropylene-based resin, a styrene-ethylene/butylene-styrene block copolymer, and a polyethylene-based resin are mixed, to which a foaming agent is added.

Preferably, the foaming polypropylene-based resin is such that the polypropylene resin includes a propylene homopolymer with a long-chain branching structure.

Preferably, the propylene homopolymer with the long-chain branching structure is a propylene homopolymer with a weight-average branching index of not more than 0.9. A weight-average branching index g′ is expressed by V1/V2, where V1 indicates a limiting viscosity number of branched polyolefin, and V2 indicates a limiting viscosity number of linear polyolefin having the same weight-average molecular weight as the branched polyolefin.

Preferably, as the foaming polypropylene-based resin, polypropylene with the melt tension at 230° C. in a range of 3 to 35 cN is used. The melt tension means the tensile force upon melting. When the melt tension is in the above range, the foaming polypropylene-based resin exhibits strain hardening, and a high expansion ratio can be obtained.

Preferably, the styrene-ethylene/butylene-styrene block copolymer has a styrene content of 15 to 40%.

Preferably, the styrene-ethylene/butylene-styrene block copolymer has a melt flow rate (MFR) at 230° C. of not more than 10 g/10 min, more preferably 1 to 10 g/10 min, and even more preferably 1 to 5 g/10 min. The MFR herein is a value measured according to JIS K-7210.

When the MFR is less than 1.0 g/10 min, compared with when the MFR is in the above ranges, shock resistance may not be obtained at low temperature.

Preferably, the polyethylene-based resin has a long-chain branching structure. From the viewpoint of shock resistance at low temperature, the polyethylene-based resin with a density of not more than 0.930 g/cm³ is preferably used.

Particularly, the polyethylene-based resin more preferably has a density of not more than 0.920 g/cm³. More preferably, with regard to the melt tension (MT) and MFR, MT×MFR is 30 (cN·g/10 min) or more. More preferably, the polyethylene-based resin contains straight-chain polyethylene with a long-chain branching structure at the terminal, as this would lead to lower density and an increase in the value of MT×MFR.

The MT is a tensile force as follows. Using a melt tension tester (from Toyo Seiki Seisaku-sho, Ltd.), a strand is extruded from an orifice with a diameter of 2.095 mm and a length 8 mm at a residual heat temperature of 230° C. and an extrusion rate of 5.7 mm/min. The MT indicates the tensile force measured when the strand is wound on a roller with a diameter of 50 mm at a winding speed of 100 rpm.

The weight mixing ratios of the foaming polypropylene-based resin, the styrene-ethylene/butylene-styrene block copolymer, and the polyethylene-based resin in the base resin is such that, with respect to the entire amount of the base resin, the foaming polypropylene-based resin is 60 to 80 wt %, the styrene-ethylene/butylene-styrene block copolymer is 15 to 35 wt %, and the polyethylene-based resin is 5 to 25 wt %. Namely, the foaming polypropylene-based resin, the styrene-ethylene/butylene-styrene block copolymer, and the polyethylene-based resin are each mixed within the ranges of the mixing ratio.

By adjusting the weight mixing ratios of the materials to be within the above ranges, a high level of foaming can be realized while shock resistance is maintained. Thus, high levels of lightweight property and thermal insulation property for a lightweight air-conditioning duct for vehicles can be realized.

The base resin is foamed by using a foaming agent before blow molding.

Examples of the foaming agent include inorganic-based foaming agents, such as air, carbonic acid gas, nitrogen gas, and water, and organic-based foaming agents, such as butane, pentane, hexane, dichloromethane, and dichloroethane.

Preferably, among those, air, carbonic acid gas, or nitrogen gas is used as the foaming agent. In this case, entry of tangible material can be prevented, so that a decrease in durability and the like can be suppressed.

Preferably, the foaming method involves the use of a supercritical fluid. Namely, it is preferable to foam the mixture resin with carbonic acid gas or nitrogen gas placed in supercritical state. In this case, uniform air bubbles can be obtained reliably.

When the supercritical fluid is nitrogen gas, conditions may include a critical temperature of −149.1° C. and a critical pressure of 3.4 MPa or higher. When the supercritical fluid is carbonic acid gas, conditions may include a critical temperature of 31° C. and a critical pressure of 7.4 MPa or higher.

By subjecting the foamed base resin to blow molding by a well-known method, the roof side duct according to the present embodiment is formed.

FIG. 3 is a cross sectional view illustrating how the roof side duct according to the present embodiment is blow-molded.

First, in an extruder, the propylene homopolymer with a long-chain branch, the propylene-ethylene block copolymer, and the low density polyethylene are kneaded at predetermined proportions so as to produce the base resin.

At this time, the mixing ratio in the base resin is defined in terms of weight ratio to the entire amount of the base resin as follows: the foaming polypropylene-based resin is 60 to 80 wt %; the styrene-ethylene/butylene-styrene block copolymer is 15 to 35 wt %; and the polyethylene-based resin is 5 to 25 wt %. The weight mixing ratio of each material is adjusted and determined such that the foaming polypropylene-based resin, the styrene-ethylene/butylene-styrene block copolymer, and the polyethylene-based resin are all within the above-described ranges.

To the obtained base resin, the foaming agent is added and mixed in the extruder, and the mixture is accumulated in an in-die accumulator (not shown). After a predetermined amount of resin is accumulated, a ring-shaped piston (not shown) is pushed vertically downward with respect to the horizontal direction.

Then, from a die slit of an extrusion head 8 illustrated in FIG. 3, a cylindrical parison 9 is extruded between split mold blocks 10 at an extrusion rate of 700 kg/h or more.

Thereafter, the split mold blocks 10 are clamped so as to sandwich the parison 9. Then, air is blown into the parison 9 in a range of 0.05 to 0.15 MPa so as to form the roof side duct 1.

Aside from forming the foam molded product by blow molding as described above, vacuum molding may be used whereby a molded product of a predetermined shape is formed by suctioning the extruded parison onto a metal mold. Further, instead of blowing or suctioning air, a foam molded product may be formed by compression molding whereby the extruded parison is sandwiched between metal molds for forming.

As described above, the roof side duct 1 according to the present embodiment is formed by adding a foaming agent into the base resin in which the foaming polypropylene-based resin, the styrene-ethylene/butylene-styrene block copolymer, and the polyethylene-based resin are mixed. Thus, the roof side duct 1 is lightweight and yet has shock resistance such that no shattering or breakage is caused without the use of a shatterproof tape even when subjected to shock in the event of deployment of a curtain air-bag, for example, at low temperature.

### Second Embodiment

Next, a second embodiment of the present invention will be described. In the second embodiment, a case will be described in which the lightweight air-conditioning duct for vehicles according to the present invention is an air-conditioning duct disposed in a floor (hereafter referred to as a “floor duct”).

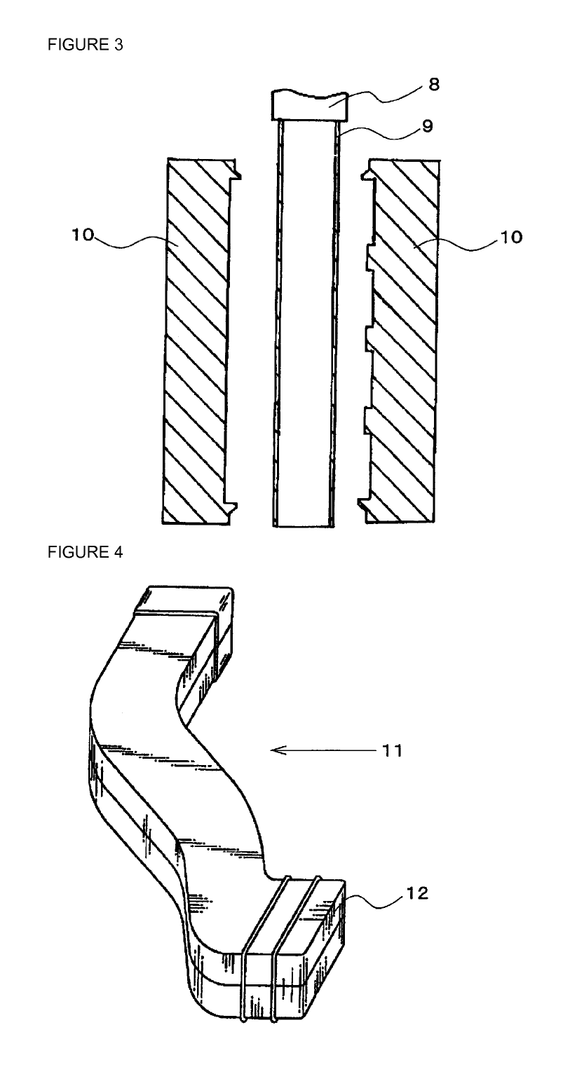

FIG. 4 is a perspective view of the floor duct according to the second embodiment.

As illustrated in FIG. 4, the floor duct 11 according to the present embodiment is for sending air-conditioning air supplied from an air conditioner unit to a desired location.

The floor duct 11 is similar to the roof side duct 1 described above with the exception that the floor duct 11 is bent in three-dimensional directions. Namely, the floor duct 11 has a hollow polygonal column shape, and is integrally formed by blow molding. The floor duct 11 is used in an opened state, with closure portions 12 at one and the other ends of the floor duct 11 cut out after blow molding.

The air-conditioning air is circulated inside the floor duct 11 and then discharged via an opened portion.

### EXAMPLES

In the following, the present invention will be described in greater detail with reference to Examples and Comparative Examples. The present invention, however, is not limited to the Examples.

The foaming polypropylene-based resins, hydrogenated styrene-based thermoplastic elastomers, and polyethylene-based resins used in the Examples and Comparative Examples are as follows.

### <Foaming Polypropylene-Based Resin>

PP1: propylene homopolymer (from Borealis AG; trade name “Daploy WB140”)
PP2: block polypropylene (from Sumitomo Chemical Company, Limited; trade name “Noblen AH561”)

### <Hydrogenated Styrene-Based Thermoplastic Elastomer>

TPE1: styrene-ethylene/butylene-styrene block copolymer (from Asahi Kasei Chemicals Corporation; trade name “Tuftec H1053”)
TPE2: styrene-ethylene/butylene-styrene block copolymer (from Asahi Kasei Chemicals Corporation; trade name “Tuftec H1062”)

### <Polyethylene-Based Resin>

PE1: high melt-strength polyethylene by low-pressure slurry method (from Tosoh Corporation; trade name “TOSOH-HMS JK17”)
PE2: straight-chain low-density polyethylene polymerized by metallocene-based catalyst (from Sumitomo Chemical Company, Limited; trade name “Excellen CB5005”)
PE3: straight-chain short-chain branching polyethylene (from Sumitomo Chemical Company, Limited; trade name “Excellen FX201”)

Table 1 shows the MT (melt tension) (cN), MFR (melt flow rate) (g/10 min), MT×MFR (cN·g/10 min), density (g/cm³), and styrene content (wt %) of these resins.

With regard to the foaming polypropylene-based resin and the hydrogenated styrene-based thermoplastic elastomer, the MT is a tensile force as follows. Using the melt tension tester (from Toyo Seiki Seisaku-sho, Ltd.), a strand is extruded out of an orifice with a diameter of 2.095 mm and a length of 8 mm at a residual heat temperature of 230° C. and an extrusion rate of 5.7 mm/min. The MT indicates the tensile force measured when the strand is wound on a roller with a diameter of 50 mm at a winding speed of 100 rpm.

The MFR is a value measured according to JIS K-7210 at a testing temperature 230° C. under a testing load of 2.16 kg.

The density is a value measured at room temperature (23° C.).

With regard to the polyethylene-based resin, the MT is a tensile force as follows. Using the melt tension tester (from Toyo Seiki Seisaku-sho, Ltd.), a strand is extruded out of an orifice with a diameter of 2.095 mm and a length of 8 mm at a residual heat temperature of 160° C. and an extrusion rate of 5.7 mm/min. The MT indicates a tensile force measured when the strand is wound on a roller with a diameter of 50 mm at a winding speed of 100 rpm.

The MFR is a value measured according to JIS K-6922-1 at a testing temperature of 190° C. under a testing load of 2.16 kg.

The density is a value measured at room temperature (23° C.).

TABLE 1

| | | | | | Styrene |
|---|---|---|---|---|---|
| | MT | MFR | MT × MFR | Density | content |
| | (cN) | (g/10 min) | (cN · g/10 min) | (g/cm³) | (wt %) |
| PP1 | 20 | 2.1 | 42 | 0.9 | — |
| PP2 | 0.8 | 3 | 2.4 | 0.9 | — |
| TPE1 | No data | 1.8 | — | 0.91 | 30 |
| TPE2 | No data | 4.5 | — | 0.89 | 18 |
| PE1 | 7.7 | 4 | 30.8 | 0.915 | — |
| PE2 | 12 | 0.4 | 4.8 | 0.924 | — |
| PE3 | 0.8 | 2 | 1.6 | 0.898 | — |

### Example 1

A base resin was obtained by mixing 70 wt % of PP1, 20 wt % of TPE1, and 10 wt % of PE1.

To the base resin, there were added nitrogen in supercritical state as a foaming agent, 1.5 parts by weight of 60 wt % talc masterbatch as a nucleating agent, and 1.5 parts by weight of 40 wt % carbon black masterbatch as a coloring agent, and the resin was foamed, obtaining a foaming resin. After kneading in an extruder, the foaming resin was accumulated in an in-die accumulator which is a cylindrical space between a mandrel and a die outer tube, and then extruded as a cylindrical parison onto split mold blocks by using a ring-shaped piston. After clamping, air was blown into the parison at a pressure of 0.1 MPa, thereby obtaining a blow molded sample.

### Example 2

A base resin was obtained by mixing 70 wt % of PP1, 25 wt % of TPE1, and 5 wt % of PE1.

A blow molded sample was obtained by performing the subsequent steps by the same method as in Example 1.

### Example 3

A base resin was obtained by mixing 70 wt % of PP1, 15 wt % of TPE1, and 15 wt % of PE1.

A blow molded sample was obtained by performing the subsequent steps by the same method as in Example 1.

### Example 4

A base resin was obtained by mixing 60 wt % of PP1, 35 wt % of TPE1, and 5 wt % of PE1.

A blow molded sample was obtained by performing the subsequent steps by the same method as in Example 1.

### Example 5

A base resin was obtained by mixing 60 wt % of PP1, 15 wt % of TPE1, and 25 wt % of PE1.

A blow molded sample was obtained by performing the subsequent steps by the same method as in Example 1.

### Example 6

A base resin was obtained by mixing 80 wt % of PP1, 15 wt % of TPE1, and 5 wt % of PE1.

A blow molded sample was obtained by performing the subsequent steps by the same method as in Example 1.

### Example 7

A base resin was obtained by mixing 75 wt % of PP1, 15 wt % of TPE2, and 10 wt % of PE1.

A blow molded sample was obtained by performing the subsequent steps by the same method as in Example 1.

### Example 8

A base resin was obtained by mixing 70 wt % of PP1, 25 wt % of TPE1, and 5 wt % of PE2.

A blow molded sample was obtained by performing the subsequent steps by the same method as in Example 1.

### Example 9

A base resin was obtained by mixing 70 wt % of PP1, 15 wt % of TPE1, and 15 wt % of PE2.

A blow molded sample was obtained by performing the subsequent steps by the same method as in Example 1.

### Example 10

A base resin was obtained by mixing 60 wt % of PP1, 35 wt % of TPE1, and 5 wt % of PE2.

A blow molded sample was obtained by performing the subsequent steps by the same method as in Example 1.

### Comparative Example 1

A base resin was obtained by mixing 70 wt % of PP1, 20 wt % of TPE2, and 10 wt % of PE3.

A blow molded sample was obtained by performing the subsequent steps by the same method as in Example 1.

### Comparative Example 2

A base resin was obtained by mixing 70 wt % of PP1, 20 wt % of TPE1, and 10 wt % of PE3.

A blow molded sample was obtained by performing the subsequent steps by the same method as in Example 1.

### Comparative Example 3

A base resin was obtained by mixing 70 wt % of PP1, 10 wt % of PP2, and 20 wt % of TPE2.

A blow molded sample was obtained by performing the subsequent steps by the same method as in Example 1.

### Comparative Example 4

A base resin was obtained by mixing 80 wt % of PP1 and 20 wt % of TPE2.

A blow molded sample was obtained by performing the subsequent steps by the same method as in Example 1.

### Comparative Example 5

A base resin was obtained by mixing 70 wt % of PP1 and 30 wt % of TPE2.

A blow molded sample was obtained by performing the subsequent steps by the same method as in Example 1.

### Comparative Example 6

A base resin was obtained by mixing 70 wt % of PP1 and 30 wt % of PE1.

A blow molded sample was obtained by performing the subsequent steps by the same method as in Example 1.

### Comparative Example 7

A base resin was obtained by mixing 70 wt % of PP1 and 30 wt % of PE2.

A blow molded sample was obtained by performing the subsequent steps by the same method as in Example 1.

The physical properties of the samples obtained in Examples 1 to 10 and Comparative Examples 1 to 7 were evaluated as follows.

### <Shock Resistance>

For shock resistance, a sphere of 1 kg was dropped onto the foam molded product samples obtained according to Examples 1 to 10 and Comparative Examples 1 to 7 at minus 10° C. When the height at which cracking developed was 120 cm or greater, the resistance was considered “Good”; the other cases were considered “Poor”.

### <Expansion Ratio>

The expansion ratio was calculated by dividing the density of the mixture resins used in Examples 1 to 10 and Comparative Examples 1 to 7 by the apparent density of a wall portion of the corresponding foam molded product samples.

### <Foaming Property>

When the expansion ratio calculated as described above was three times or more, the property was considered “Good”; other cases were considered “Poor”.

Table 2 shows the mixing ratios in the base resin of PP1, PP2, TPE1, TPE2, and PE1 to PE3 according to Examples 1 to 10 and Comparative Examples 1 to 7, and the shock resistance, foaming property, and expansion ratio evaluated as described above.

TABLE 2

| | | | | | | | | | | Expansion |
|---|---|---|---|---|---|---|---|---|---|---|
| | Mixing ratio (%) in base resin | | | | | | | Shock | Foaming | ratio |
| | PP1 | PP2 | TPE1 | TPE2 | PE1 | PE2 | PE3 | resistance | property | (times) |
| Example 1 | 70 | | 20 | | 10 | | | Good | Good | 3.5 |
| Example 2 | 70 | | 25 | | 5 | | | Good | Good | 3.5 |
| Example 3 | 70 | | 15 | | 15 | | | Good | Good | 3.8 |
| Example 4 | 60 | | 35 | | 5 | | | Good | Good | 3.3 |
| Example 5 | 60 | | 15 | | 25 | | | Good | Good | 3.7 |
| Example 6 | 80 | | 15 | | 5 | | | Good | Good | 4.0 |
| Example 7 | 75 | | | 15 | 10 | | | Good | Good | 3.8 |
| Example 8 | 70 | | 25 | | | 5 | | Good | Good | 3.3 |
| Example 9 | 70 | | 15 | | | 15 | | Good | Good | 3.3 |
| Example 10 | 60 | | 35 | | | 5 | | Good | Good | 3.1 |
| Comparative | 70 | | | 20 | | | 10 | Good | Poor | 2.8 |
| Example 1 | | | | | | | | | | |
| Comparative | 70 | | 20 | | | | 10 | Good | Poor | 2.7 |
| Example 2 | | | | | | | | | | |
| Comparative | 70 | 10 | | 20 | | | | Poor | Poor | 2.5 |
| Example 3 | | | | | | | | | | |
| Comparative | 80 | | | 20 | | | | Poor | Good | 3.3 |
| Example 4 | | | | | | | | | | |
| Comparative | 70 | | | 30 | | | | Good | Poor | 2.2 |
| Example 5 | | | | | | | | | | |
| Comparative | 70 | | | | 30 | | | Poor | Good | 3.6 |
| Example 6 | | | | | | | | | | |
| Comparative | 70 | | | | | 30 | | Poor | Good | 3.4 |
| Example 7 | | | | | | | | | | |

In the samples according to Examples 1 to 10, the weight mixing ratio of PP1, which is a high melt tension polypropylene with a long-chain branching structure as a foaming polypropylene-based resin, is 60 to 80 wt % of the base resin as a whole.

The weight mixing ratio of TPE1 or TPE2 with the styrene content of 15 to 40% as a styrene-ethylene/butylene-styrene block copolymer is 15 to 35 wt % of the base resin as a whole.

In the samples according to Example 1 to 7 among Examples 1 to 10, as the polyethylene-based resin, PE1, which is polyethylene with a long-chain branching structure and with the density of not more than 0.920 g/cm³ and the MT×MFR value of not less than 30 (cN·g/10 min), was used. In the samples according to Example 1 to 7, the weight mixing ratio of PE1 was 5 to 25 wt % of the base resin as a whole.

In the samples according to Example 8 to 10, as the polyethylene-based resin, PE2, which is polyethylene with a long-chain branching structure and with the density of not more than 0.930 g/cm³ was used. In the samples according to Example 8 to 10, the weight mixing ratio of PE2 was 5 to 25 wt % of the base resin as a whole.

Due to such mixing ratios, in the samples according to Examples 1 to 10, the expansion ratio was more than 3.0 times. Further, with regard to shock resistance, the condition that the height at which cracking develops upon dropping of the 1 kg-sphere at minus 10° C. is 120 cm was cleared.

Thus, the samples according to Examples 1 to 10 have sufficient shock resistance that there is no need to affix a shatterproof tape on the air-bag. Further, the expansion ratio of 3.0 times or more can be obtained. Accordingly, high levels of lightweight property and thermal insulation property can be realized.

In particular, among Example 1 to 7 in which PE1 was used as the polyethylene-based resin, the expansion ratio is more than 3.5 times in Examples 1 to 3 and 5 to 7. Thus, these Examples have sufficient shock resistance that there is no need for affixing a shatterproof tape on the air-bag. Further, even higher levels of lightweight property and thermal insulation property can be realized.

On the other hand, in Comparative Examples 1 and 2, the weight mixing ratio of the foaming polypropylene-based resin was 70 wt % of the base resin as a whole, and the weight mixing ratio of the styrene-ethylene/butylene-styrene block copolymer was 20 wt % of the base resin as a whole. In addition, PE3 was used as the polyethylene-based resin, and the weight mixing ratio of PE3 was 10 wt % of the base resin as a whole. Accordingly, with respect to shock resistance, the condition of eliminating the need for shatterproof tape was cleared. However, in Comparative Examples 1 and 2, the expansion ratio could not be 3 times or greater.

In Comparative Examples 3 and 4, the weight mixing ratio of the foaming polypropylene-based resin was 80 wt % of the base resin as a whole, and the weight mixing ratio of the styrene-ethylene/butylene-styrene block copolymer was 20 wt % of the base resin as a whole. However, with regard to shock resistance, the condition of eliminating the need for shatterproof tape could not be cleared.

In Comparative Example 5, the weight mixing ratio of the foaming polypropylene-based resin was 70 wt % of the base resin as a whole. Further, the weight mixing ratio of the styrene-ethylene/butylene-styrene block copolymer was 30 wt % of the base resin as a whole, which was greater than in Comparative Examples 3 and 4. Thus, with regard to shock resistance, the condition of eliminating the need for shatterproof tape was cleared. However, surface defoaming was exacerbated. As a result, the expansion ratio was decreased and could not be 3 times or greater.

In Comparative Examples 6 and 7, the weight mixing ratio of the foaming polypropylene-based resin was 70 wt % of the base resin as a whole, and the weight mixing ratio of PE1 or PE2 as the polyethylene-based resin was 30 wt % of the base resin as a whole. However, in Comparative Examples 6 and 7, with regard to shock resistance, the condition of eliminating the need for shatterproof tape could not be cleared.

Thus, in the samples according to Comparative Examples 1, 2, 3, and 5, the expansion ratio was less than 3.0 times. In the samples according to Comparative Examples 3, 4, 6, and 7, with regard to shock resistance, the condition that the height at which cracking develops upon dropping of the 1 kg-sphere at minus 10° C. is 120 cm was not cleared.

Hence, in Comparative Examples 1 to 7, improvements in both foaming property and shock resistance could not be achieved.

It should be noted that the present invention is not limited to the lightweight air-conditioning duct for vehicles, but may be used for housings for automobile, aircraft, vehicle/shipping, building material, and various electric equipment purposes, and for structure members and the like for sports/leisure purposes. The present invention can contribute to a decrease in automobile weight when used for automobile structure members, such as interior panels including a cargo floor board, a deck board, a rear parcel shelf, a roof panel, and a door trim; door inner panels; platforms; hard-tops; sun-roofs; hoods; bumpers; floor spacers; or tibia pads. As a result, fuel economy can be improved.

### INDUSTRIAL APPLICABILITY

The foam molded product according to the present invention may be suitably utilized as a vehicle air-conditioning duct, particularly a thin and lightweight roof side duct that is disposed adjacent to a curtain air-bag or the like and from which shock resistance is required.

The vehicle air-conditioning duct can contribute to a decrease in the weight of vehicles without a decrease in various physical properties, such as mechanical strength. Further, the vehicle air-conditioning duct eliminates the need for shatterproof tape, thus also contributing to cost reductions.

This application is based on Japanese Patent Application No. 2011-253000 filed on Nov. 18, 2011, the entire content of which is hereby incorporated by reference.

### DESCRIPTION OF REFERENCE SIGNS

1 Roof side duct (lightweight air-conditioning duct for vehicles)
1a Wall portion
2 Air supply opening
3 Transverse duct
4 Vehicle body panel
5 Air discharge opening
6 Interior roof material
7 Curtain air-bag
8 Extrusion head
9 Parison
10 Split mold block
11 Floor duct (lightweight air-conditioning duct for vehicles)
12 Closure portion

1. A foam molded product comprising:
a mixture resin including, as base resins,
a polypropylene-based resin with a long-chain branching structure and a weight mixing ratio of 60 to 80%;
a styrene-ethylene/butylene-styrene block copolymer with a styrene content of 15 to 40% and a weight mixing ratio of 15 to 35%; and
a polyethylene-based resin with a long-chain branching structure, a density of not more than 0.930 g/cm³, and a weight mixing ratio of 5 to 25%.

2. The foam molded product according to claim 1, wherein the expansion ratio is three times or greater.

3. The foam molded product according to claim 1, wherein the polyethylene-based resin has a density of not more than 0.920 g/cm³, and a melt tension (MT) and a melt flow rate (MFR) that satisfy the following expression:
MT×MFR≧30 (cN·g/10 min).

4. The foam molded product according to claim 2, wherein the polyethylene-based resin has a density of not more than 0.920 g/cm³, and a melt tension (MT) and a melt flow rate (MFR) that satisfy the following expression:
MT×MFR≧30 (cN·g/10 min).

5. The foam molded product according to claim 1, wherein a tensile fracture elongation of the foam molded product is not less than 40% at −10° C.

6. The foam molded product according to claim 1, wherein the foam molded product is a vehicle air-conditioning duct.

7. The foam molded product according to claim 6, wherein the vehicle air-conditioning duct is a roof side duct.

8. A method for producing a foam molded product comprising:
obtaining a base resin by mixing
a polypropylene-based resin with a long-chain branching structure and a weight mixing ratio of 60 to 80%,
a styrene-ethylene/butylene-styrene block copolymer with a styrene content of 15 to 40%, and a weight mixing ratio of 15 to 35%, and a polyethylene-based resin with a long-chain branching structure, a density of not more than 0.930 g/cm³, and a weight mixing ratio of 5 to 25%; and
adding a foaming agent to the base resin and foam-molding the base resin.

9. The method for producing a foam molded product according to claim 8, further comprising:
using air, carbonic acid gas, or nitrogen gas as the foaming agent.

10. The method for producing a foam molded product according to claim 9, further comprising:
using the carbonic acid gas or the nitrogen gas in supercritical state.
